(19) United States
(12) Patent Application Publication
(10) Pub. No.: US 2021/0114756 A1
(43) Pub. Date: Apr. 22, 2021

(54) TRAY SLEEVER

(71) Applicant: Carter Control Systems, Inc., Frederick, MD (US)

(72) Inventor: Cliff D. Fettner, Frederick, MD (US)

(21) Appl. No.: 17/065,301

(22) Filed: Oct. 7, 2020

Related U.S. Application Data
(60) Provisional application No. 62/916,052, filed on Oct. 16, 2019.

(51) Int. Cl. B65B 43/26; B65B 39/06

(52) U.S. Cl. CPC B65B 43/265; B65B 5/04; B65B 39/06

(57) ABSTRACT

A tray sleeving system includes a robotic arm, an end-of-arm tool operably connected to the robotic arm and configured to selectively hold a sleeve blank, a conveyor system having a first sidewall proximate the robotic arm and a second sidewall distal from the robotic arm and separated from the first sidewall by a conveyor, a processor, and a memory. The memory stores instructions for execution by the processor that, when executed, cause the processor to cause the robotic arm to retrieve a sleeve blank with the end-of-arm tool; cause the robotic arm to push the sleeve blank against the second sidewall so as to cause the sleeve blank to transition from a flattened state to an open state; and cause the robotic arm to release the sleeve blank into a loading position on the conveyor.

### CROSS REFERENCE TO RELATED APPLICATIONS

This application claims priority to and the benefit of U.S. Provisional Application No. 62/916,052, filed on Oct. 16, 2019, which is incorporated herein by reference in its entirety.

### GOVERNMENT LICENSE RIGHTS

This invention was made with government support under Contract No. 3AMATH-17-B-0076 awarded by the United States Postal Service. The government has certain rights in the invention.

### FIELD OF THE DISCLOSURE

The present disclosure relates to systems for placing trays within sleeves, and more particularly to automated systems for placing trays within sleeves.

### BACKGROUND

To facilitate efficient transportation of envelopes and other small packages (collectively referred to herein as “mail pieces”), such mail pieces may be sorted into open-topped trays by destination, which trays may then be placed within sleeves to ensure that no mail pieces fall out of the open-topped trays during shipment. Originally, sleeves were placed on trays manually—a repetitive and time-consuming process. Eventually, the process of tray sleeving was automated.

U.S. Pat. No. 8,621,831 describes a “Robotic Mail Tray Sleever Apparatus” that includes a conveyor system for transporting a mail tray, a sleeve blank presentment device and a robotic arm. The robotic arm is provided with an end of arm tool which retains and opens a sleeve blank. A tray induction system with a plurality of paddles is configured to guide a tray into an open sleeve blank.

### SUMMARY

According to some embodiments of the present disclosure, an automated robotic tray sleever comprises a robotic arm that picks a flattened sleeve of an appropriate size from one of a plurality sleeve hoppers (one or more of which may hold sleeves of a first size, and others of which may hold sleeves of a second size, a third size, a fourth size, etc.) and pushes the flattened sleeve against a sidewall of a nearby conveyor system to cause the sleeve to open. One or more suction devices are utilized to hold the opened sleeve in position while a tray is pushed into the sleeve by an automated tray loading device, after which the suction devices release the loaded sleeve for transport by the conveyor system.

According to some embodiments of the present disclosure, one or more of the plurality of sleeve hoppers comprises a conveyor system that supports a downward-facing edge of the flattened sleeves loaded therein. The forward-most flattened sleeve in the sleeve hopper is available to be picked up by the robotic arm of the automated robotic tray sleever, while a bar of a cable reel and bar system selectively pushes on the rearward-most flattened sleeve in the sleeve hopper and thus works in conjunction with the conveyor system of the hopper to move the sleeves in the hopper forward when the forward-most flattened sleeve is removed by the robotic arm.

The terms “memory,” “computer-readable medium” and “computer-readable memory” are used interchangeably and, as used herein, refer to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable medium is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a plan view of a tray sleever system according to at least some embodiments of the present disclosure;

FIG. 2 is a cross-sectional view of a portion of a tray sleever system in a first operational position according to at least some embodiments of the present disclosure;

FIG. 3 is a cross-sectional view of a portion of a tray sleever system in a second operational position according to at least some embodiments of the present disclosure;

FIG. 4 is a cross-sectional view of a portion of a tray sleever system in a third operational position according to at least some embodiments of the present disclosure; and

FIG. 5 is a block diagram of a tray sleever system according to at least some embodiments of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

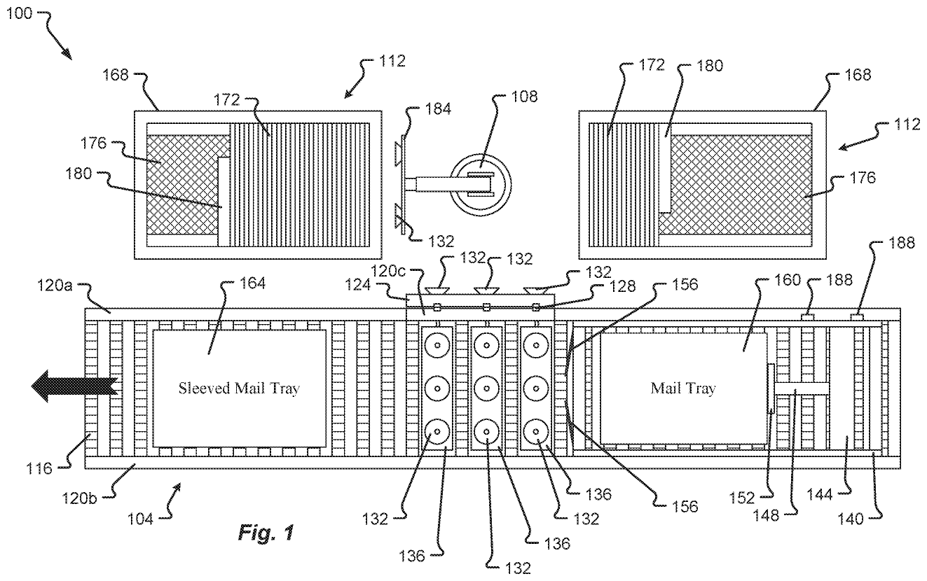

Referring first to FIG. 1, an automatic tray sleever system 100 (shown in a top plan view in FIG. 1) comprises a conveyor system 104, a robotic arm 108, and one or more hopper bays 112.

The robotic arm 108 may be any kind of robotic arm capable of retrieving an object in a first, substantially vertical orientation from a first location, and depositing the object in a second, substantially horizontal orientation from a second location. The robotic arm 108 may be, for example, an IRB 1200/5 Series articulated robot. The robotic arm 108 may comprise one or more joints, and may comprise one or more motors, pneumatic systems, hydraulic systems, any combination of the foregoing, or any other appropriate system or combination of systems for causing the robotic arm 108 to move in a desired path. The robotic arm 108 may further comprise a control unit for controlling movement of the comprising, for example, a processor and a memory, and/or the robotic arm 108 may receive control signals from a separate control unit. Specialized software may be stored in a memory and executed by a process of any such control unit to control the operation of the robotic arm 108. The robotic arm 108 may be pedestal mounted.

The robotic arm 108 comprises an end of arm tool 184 operatively coupled to the robotic arm 108. The end of arm tool 184 is configured to selectively hold a sleeve blank 172. For example, the end of arm tool 184 may comprise a plate to which one or more selectively operable suction cups 132 are mounted. The plate may be made of metal, wood, composite, plastic, or any other material suitable for supporting the suction cups 132. When the suction cups 132 are activated, the end of arm tool 184 may be used to retrieve a sleeve 172 from a hopper bay 112 and place the sleeve 172 on the conveyor system 104. Once the sleeve 172 is opened, the suctions cups 132 on the end of arm tool 184 may deactivate to release the sleeve 172. The robotic arm 108 may then rotate back into position to select another sleeve 172 from a hopper bay 112. In some aspects, the suctions cups 132 mounted on the end of arm tool 184 do not deactivate until after the mail tray 160 is loaded into the opened sleeve 172.

Each of the one or more hopper bays 112 is configured to hold a plurality of empty, flattened sleeves 172 (also referred to as sleeve blanks). In some aspects, one of the hopper bays 112 holds sleeve blanks of a different size than those held by another hopper bay 112. Each of the one or more hopper bays 112 comprises a hopper frame 168. The frame 168 of the hopper bay 112 may support a conveyer system 176 that at least partially supports the sleeve blanks 172 stored by the hopper bay 112. The conveyor system 176 may be, for example, a low-voltage conveyor system. The conveyor system 176 may comprise a powered roller driven belt conveyor. In some aspects, the slider bed belt conveyor may comprise an anti-slip surface, and may comprise a first end connected (via lacing or otherwise) to a second end to form a continuous loop. The conveyor system 176 may be bolted or otherwise attached to the frame 168.

The conveyor system 176 may further comprise a proximity sensor (or other type of sensor) positioned and configured to detect whether a sleeve blank 172 is present at the opening of the hopper frame 168 (from where the robotic arm 108 would retrieve a sleeve blank from the hopper bay 112). If the proximity sensor (or other type of sensor) detects that no sleeve blank 172 is present in the opening, the conveyor system 176 may automatically advance the sleeve blanks 172 toward the opening of the frame 168 and toward the robotic arm 108. The proximity sensor may be, for example, a photoelectric sensor, an inductive sensor, and/or a laser sensor.

The one or more hopper bays 112 may also, or alternatively, include a reel-and-cable driven push bar 180 or other tensioner system that pushes against the sleeve blanks 172 to keep them upright, and, together with the conveyor system 176, to advance the sleeve blanks 172 toward the robotic arm 108. The reel-and-cable push bar 180 may be configured to selectively exert force on the sleeves 172 in the direction of the robotic arm 108, or to exert a constant pressure on the sleeves 172 in the direction of the robotic arm 108. The push bar 180 may be driven by a spring-loaded reel tensioner and steel cable that applies force on the push bar 180 to keep the stack of sleeve blanks 172 compressed and also to track the movement of the conveyor system 176. The push bar 180 may be slidably attached to a pillow block bearing along a side rail running the length of the hopper bay 112. Additionally, the push bar 180 may comprise a vertically mounted plate configured to apply pressure to the back of the last sleeve blank in the hopper bay 112. A latching mechanism may be provided to hold the push bar 180 in place (e.g., in a fully retracted position) while sleeve blanks are loaded into the hopper bay 112. Each hopper bay 112 may include either the reel-and-cable driven push bar 180 or the conveyor system 176, or both the reel-and-cable driven push bar 180 and the conveyor system 176.

The hopper bays 112 may also include one or more sensors for detecting the size of the sleeve blanks loaded into the hopper bay 112, and/or for detecting how full of sleeve blanks is the hopper bay 112. In embodiments in which the hopper bays 112 include one or more sensors for detecting the size of the sleeve blanks in the hopper bay 112, the size information may be utilized to ensure that the robotic arm 108 selects a sleeve blank from a hopper bay 112 holding the desired size of sleeve blanks. In embodiments in which the hopper bays 112 include one or more sensors for detecting how full of sleeve blanks is the hopper bay 112, such information may be utilized to determine when the hopper bay 112 needs to be refilled with sleeve blanks.

The conveyor system 104 may be divided into a plurality of zones, such as an in-feed/inserter zone (extending underneath the tray loading system frame 140, and encompassing the portion of the conveyor system 104 along which a tray progresses prior to sleeving); a sleeving zone (extending along the length of the sidewall 120c, and encompassing the portion of the conveyor system 104 in which a tray is inserted into a sleeve blank); and a take-away zone (extending from the sleeving zone along the direction of travel, and encompassing the portion of the conveyor system 104 that conveys a sleeved tray away from the sleeving zone). Each zone comprises one or more rollers 116 positioned between a conveyor sidewall 120a or 120c on one side, and a conveyor sidewall 120b on the other. One or more of the rollers 116 in each zone may be a powered or drive roller, while one or more other rollers 116 in each zone may be an idler roller, which may or may not be connected to a powered or drive roller (whether directly or indirectly) via one or more O-rings, chains, or other force transmitting linkages. Each zone is therefore independently operable of the other zones. One or more of the rollers 116 may be provided with a friction-enhancing coating to prevent slippage between the roller 116 and a tray 160 or sleeved tray 164. Although the conveyor system 104 is illustrated in FIG. 1 as utilizing rollers 116, in other embodiments the conveyor system 104 The conveyor 228 may be, for example, a belt conveyor, a chain conveyor, or any other type of conveyor useful for the purposes described herein.

In the sleeving zone of the conveyor system 104, a flap 124 is rotatably connected to the conveyor sidewall 120c via a plurality of hinges 128. The flap 124 may be formed, for example, of metal, plastic, composite, wood, or any other suitable material. In some embodiments, the flap 124 may comprise a metal bracket to which a plastic top plate is attached. A plurality of selectively operable suction cups 132 are provided on the flap 124. The suction cups 132 may be configured to activate automatically when the flap 124 is rotated into an upright position (so as to be aligned with the sidewalls 120a and 120c), or activation of the suction cups 132 may be controlled independently of the position of the flap 124. The flap 124 may be, for example, pneumatically operated, or mechanically operated, or magnetically operated.

In some embodiments, the sleeving zone may be narrower than other zones of the conveyor system 104.

Also included in the sleeving zone of the conveyor system 104 are a plurality of pop-up suction cup mounts 136, which are configured to be selectively raised and lowered. Each pop-up suction cup mount 136 comprises a plurality of selectively operable suction cups 132. The suction cups 132 may be configured to activate automatically when the flap 124 is rotated into an upright position (so as to be aligned with the sidewalls 120a and 120c), or activation of the suction cups 132 may be controlled independently of the position of the flap 124. The suction cups 132 may also be configured to activate automatically when the pop-up suction cup mounts 136 are raised (or vice versa), and to deactivate automatically when the pop-up suction cup mounts 136 are lowered (or vice-versa). The pop-up suction cup mounts 136 may be, for example, pneumatically operated, or mechanically operated, or magnetically operated. In some embodiments, one or more of the rollers 116 in the sleeving zone may be provided with an oblong, elliptical or oval cross section (as opposed to a circular cross-section) to assist in breaking the suction applied to a sleeve when the pop-up suction cup mounts 136 retract.

The in-feed/inserter zone of the conveyor system 104 comprises a tray loading system frame 140, a tray advancement driver 144, a tray advancement arm 148, a tray advancement panel 152, and paddles 156.

The tray loading system frame 140 may simply be a box frame that extends upward from the sidewalls 120a and 120b of the conveyor system 104. The tray loading system frame 140 supports the tray advancement driver 144, which is slidably mounted to the tray loading system frame so as to be able to move forward and backward along the frame 140 in the direction of travel of the conveyor system 104.

A tray advancement arm 148 is secured to the tray advancement driver 144, and supports a tray advancement panel 152. The tray advancement arm 148 may be rotatably connected to the tray advancement driver 144, so as to be able to rotate between a raised position (in which the tray advancement arm 148 and the tray advancement panel 152 are proximate the top of the tray loading system frame 140) and a lowered position (in which the tray advancement arm 148 extends downward from the tray advancement driver 144 to proximate the rollers 116, such that the tray advancement panel 152 is positioned to push a tray into an awaiting sleeve blank in the sleeving zone of the conveyor system 104. In some embodiments, however, the tray advancement arm 148 may be fixedly secured to the tray advancement driver 144, and the tray advancement driver 144 may be both slidably and rotatably secured to the tray loading system frame 140 to permit the tray advancement arm 148 and the tray advancement panel 152 to move between raised and lowered positions.

When a mail tray 160 arrives at the tray loading system frame 140 along the in-feed/inserter zone of the conveyor system 104, the tray advancement driver 140 is positioned at the intake end of the tray loading system frame 140 (e.g., the end through which a mail tray 160 first passes as it moves along the conveyor system 104) and the advancement arm 148 and the tray advancement panel 152 are in the raised position, thus allowing the mail tray 160 to move along the conveyor system 104 underneath the tray advancement arm 148 and panel 152. Once the mail tray 160 has passed the tray advancement panel 152, the tray advancement arm 148 and panel 152 rotate into the lowered position, and the tray advancement driver 144 moves along the tray loading system frame 140 in the direction of travel of the conveyor system 104. This causes the tray advancement panel 152 to contact the rear side of the mail tray 160 and push the mail tray 160 into an awaiting sleeve blank in the sleeving zone of the conveyor system 104. The panel 152 beneficially applies force across the rear edge or surface of the mail tray 160.

The tray advancement driver 144 may comprise or be operably secured to an electric servo motor driving a linear slide, or to a linear motor, or to any other powered mechanism for selectively moving the tray advancement driver 144 forward and backward along the tray loading system frame 140. In embodiments where the tray advancement arm 148 is rotatably secured to the tray advancement driver 144, movement of the tray advancement arm 148 between the raised and lowered positions may be controlled by a pneumatic cylinder, or by a motor, or by any other suitable mechanism. In some embodiments, movement of the tray advancement arm 148 from the lowered to the raised position occurs automatically when the tray advancement driver 144 moves backward along the tray loading system frame 140.

One or more tray sensors 188 determine the size of the mail tray 160 entering the tray loading system frame 140. For example, the sensors may determine the height and length of the mail tray 160. The sensors 108 may be retro-reflective sensors, laser sensors, proximity sensors, or other sensors, and the size of the mail tray 160 may be determined solely based on information from the sensors 188, or may be determined based on calculations that utilize information such as the speed of operation of the conveyor system 104 (or at least of the in-feed/inserter zone of the conveyor system 104), the time at which one or more of the sensors 188 were activated, and so forth.

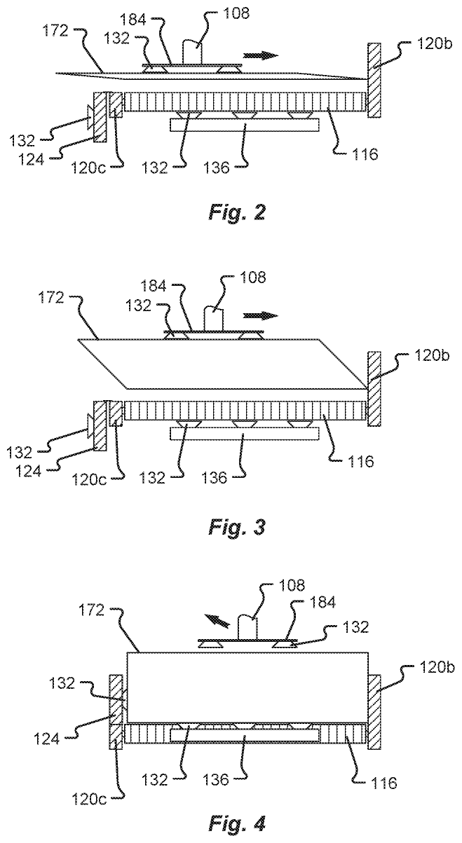

Once the size of the mail tray 160 is determined, this information is relayed to the robotic arm 108 or otherwise used to control the robotic arm 108. The robotic arm 108 selects the corresponding hopper bay 112 holding sleeve blanks 172 of a size corresponding to the determined size of the mail tray 160. Using the end of arm tool 184, the robotic arm 108 removes a sleeve blank 172 from the selected hopper bay 112, and places the sleeve blank 172 on the sleeving zone of the conveyor system 104 while simultaneously opening the sleeve blank 172 (as discussed below in connection with FIGS. 2-4). The tray advancement arm 148 and panel 152 are moved into the lowered position, and the tray advancement driver 144 (together with the tray advancement arm 148 and panel 152) pushes the tray 160 into the sleeve blank 172.

The sleeved mail tray 164 is then released from the sleeving zone of the conveyor system 104, and the take-away zone of the conveyor system 104 carries away the sleeved mail tray 164.

The conveyor system 104 also includes a plurality of paddles 156, which may be mounted for example, to the tray loading system frame 140 and/or to the sidewalls 120a and 120b. In some embodiments, the conveyor system 104 comprises two paddles 156, each rotatably mounted on a vertical axis. In other embodiments, the conveyor system 104 comprises four paddles 156, with two paddles 156 rotatably mounted on a vertical axis and two additional paddles 156 mounted on a horizontal axis (with the horizontal axis of one such paddle 156 proximate and parallel to the rollers 116, and the horizontal axis of the other such paddle 156 mounted to the tray loading system frame 140 and also parallel to the rollers 116). In either embodiment, as the tray advancement driver 144 pushes a mail tray 160 forward through the forward end of the tray loading system frame 140, the mail tray 160 contacts the paddles 156 and causes them to rotate into the open end of an awaiting sleeve blank 172. The paddles 156 thus prevent the forward edges of the mail tray 160 from catching on the rearward edges of the sleeve blank 172, so as to beneficially prevent loading errors and increase the operating efficiency of the automatic tray sleever system 100.

Turning now to FIGS. 2-4, a method of opening a sleeve blank 172 according to embodiments of the present disclosure is illustrated. FIGS. 2-4 provide a cross-sectional view of a conveyor system 104, taken at the forward edge of a sleeving zone of the conveyor system 104 and looking rearward at the sleeving zone. Thus, FIGS. 2-4 illustrate the conveyor sidewalls 120b and 120c; a roller 116 extending therebetween; the flap 124 with its suction cups 132, rotatably mounted to the sidewall 120c; and a pop-up suction cup mount 136 with its suction cups 132. In FIG. 2, the robotic arm 108 is holding a sleeve blank 162 with the suction cups 132 of its end of arm tool 184. The robotic arm 108 positions the sleeve blank 172 directly above and parallel to the rollers 116 of the sleeving zone of the conveyor system 104, and moves the sleeve blank 172 sideways until it contacts the sidewall 120b.

As shown in FIG. 3, the sidewall 120b prevents the contacted corner of the sleeve blank 172 (and, as a result, the entire bottom surface of the sleeve blank 172) from moving even as the robotic arm 108 (gripping the upper surface of the sleeve blank 172) continues to move sideways toward the sidewall 120b. The relative motion between the bottom surface of the sleeve blank 172 and the upper surface of the sleeve blank 172 causes the sides of the sleeve blank 172 to rotate from a substantially horizontal orientation to a substantially vertical orientation.

As shown in FIG. 4, as the sleeve blank 172 reaches a fully opened configuration, the flap 124 rotates into place and the suction cups 132 thereon activate to hold the side of the sleeve blank 172 in place, and the pop-up suction cup mounts 136 move into the raised position with the suction cups 132 thereon activated to secure the bottom of the sleeve blank 172 in place. The suction cups 132 on the end of arm tool 184 of the robotic arm 108 are deactivated, thus allowing the robotic arm 108 to release the sleeve blank 172. The robotic arm 108 is then free to retrieve another sleeve blank 172. Meanwhile, a mail tray 160 is loaded into the opened sleeve blank 172 on the conveyor system 104, after which the suction cups 132 on the folding flap 124 and on the pop-up suction cup mounts 136 are de-activated, the flap rotates back into its lowered position, and the pop-up suction cup mounts 136 retract into their lowered position.

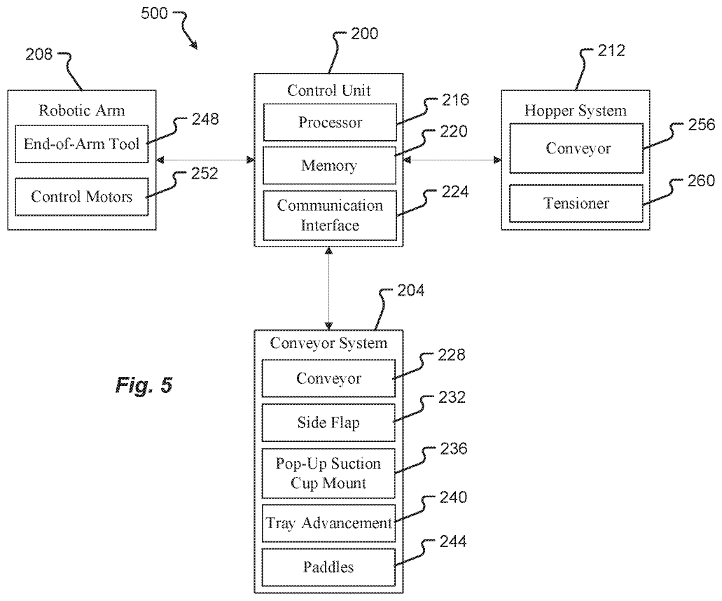

FIG. 5 is a block diagram of an automatic tray sleever system 500 according to embodiments of the present disclosure. The system 500 comprises a control unit 200, a conveyor system 204, a robotic arm 208, and a hopper system 212.

The control unit 200 includes a processor 216, a memory 220, and a communication interface 224.

The processor 216 may correspond to one or multiple microprocessors. The processor 216 may comprise a Central Processing Unit (CPU) on a single Integrated Circuit (IC) or a few IC chips. The processor 216 may be a multipurpose, programmable device that accepts digital data as input, processes the digital data according to instructions stored in its internal memory, and provides results as output. The processor 216 may implement sequential digital logic, as it has internal memory. As with most known microprocessors, the processor 216 may operate on numbers and symbols represented in the binary numeral system. The processor 216 may execute instructions stored in a firmware thereof, and may also execute instructions stored in the memory 220. As part of the control unit 200, the processor 216 may be used to control one or more aspects of the tray sleever system 500, including the conveyor system 204, the robotic arm 208, and/or the hopper system 212. The processor 216 may also be used to read data from or to write data to the memory 220. A control unit 200 may also be utilized in connection with the automatic tray sleever system 100, and may therefore be utilized to control one or more aspects of the conveyor system 104, the robotic arm 108, and the hopper bays 112.

The memory 220 may correspond to any type of non-transitory computer-readable medium. In some embodiments, the memory 220 may comprise volatile or non-volatile memory and a controller for the same. Non-limiting examples of memory 220 that may be utilized in the tray sleever system 100 include RAM, ROM, buffer memory, flash memory, solid-state memory, or variants thereof.

The memory 220 may include a firmware section that may store any electronic data (including instructions) needed for operation of the control unit 200. For example, the memory 220 may store any firmware needed for allowing the processor 216 to operate and/or communicate with the various components of the control unit 200, as needed, and to communicate with the components of the tray sleever system 100 or 500, such as the conveyor system 104/204, the robotic arm 108/208, and/or the hopper bay 112/212 or other computing devices connected to the control unit 200 via the communication interface 224.

The communication interface 224 comprises hardware and/or software that allows the control unit 200 to connect with the various components of the tray sleever system 100 or 500 to transmit data communications. The communication interface 224 thus allows the control unit 200 to connect to the Internet or another wide-area or local-area network. The communication interface 224 may be used to receive software or firmware updates for the control unit 200; to receive user input and/or commands from an external computing device, including to modify one or more settings of the control unit 200.

The communication interface 224 may comprise a Bluetooth interface, a Wi-Fi card, a Network Interface Card (NIC), a cellular interface (e.g., antenna, filters, and associated circuitry) (such as, for example, a 3G interface, a 4G interface, or an LTE interface), a near field communication (NFC) interface, a ZigBee interface, a FeliCa interface, a MiWi interface, a Bluetooth interface, a Bluetooth low energy (BLE) interface, or the like. Regardless of the protocol used by the communication interface 224, the communication interface 224 may comprise, for example, a transmitter, a receiver, and an antenna, and may also comprise software or firmware needed to operate such components.

The system 500 also comprises a conveyor system 204, which in turn may comprise one or more controllable elements. For example, the conveyor system 204 may include one or more conveyor actuators 228, which may be utilized to control one or more zones of a conveyor system such as the conveyor system 104, each of which zones may be selectively operable.

The conveyor system 204 may include a side flap actuator 232, which is operable to move a flap such as the flap 124 from an inactive position to an active position, and/or which is operable to selectively activate the one or more selectively operable suction cups 132 or other selectively operable gripping devices secured thereto.

The conveyor system 204 may further include one or more pop-up suction cup mount actuators 236, which are selectively operable to move a pop-up suction cup mount such as the pop-up suction cup mounts 136 from an inactive position to an active position, and/or which is operable to selectively activate the one or more selectively operable suction cups 132 or other selectively operable gripping devices secured thereto.

The conveyor system 204 may further include a tray advancement system actuator 240, which is used to control the operation of a tray advancement driver 144 and tray advancement arm 148, or of an alternative system for selectively pushing trays into empty sleeve blanks.

The conveyor system 204 may further include one or more paddle actuators 244. In embodiments of the present disclosure utilizing actively controlled paddles (as opposed to the passive paddles 156 described above), the paddles may be selectively moved by a motor or other actuator 244 between a loading position and a resting position.

The automatic tray sleever system 500 also comprises a robotic arm 208. The robotic arm 208 comprises an end of arm tool actuator 248 that is useful to control the operation of one or more selectively operable suction cups 132 or other selectively operable gripping devices provided on an end of arm tool 184 or similar end of arm tool.

The robotic arm 208 may further comprise one or more control motor actuators 252. These control motor actuators 252 may be utilized, for example, to control movement of a robotic arm such as the robotic arm 108.

The automatic tray sleever system 500 also comprises a hopper system 212. The hopper system 212 may include a conveyor actuator 266 and/or a tensioner actuator 260. The conveyor actuator 266 may be utilized to control a conveyor system such as the conveyor system 175 to selectively advance sleeve blanks 172 in a hopper bay 112 toward a robotic arm 108 each time a sleeve 172 is removed from the hopper bay 112. The tensioner actuator 260 may selectively operate a reel-and-cable driven push bar 180 (where such reel-and-cable drive push bar is an active, rather than a passive, system) and/or another tensioner device to push against sleeve blanks 172 loaded into a hopper bay 112 and to keep the sleeves 172 in an upright position.

Aspects of the foregoing tray sleeving system comprise: wherein the end-of-arm tool comprises a plurality of selectively operable suction cups; wherein the conveyor system further comprises a plurality of suction cups configured to selectively secure the sleeve blank in the loading position of the conveyor; wherein the first sidewall comprises a flap portion, the flap portion rotatable between a first, lowered position and a second, raised position; wherein the flap portion comprises a plurality of selectively operable suction cups configured to secure the sleeve blank in the loading position of the conveyor when the flap portion is in the second, raised position; wherein the conveyor system further comprises a suction cup mount selectively movable vertically from a lowered position to a raised position, the suction cup mount comprising a plurality of suction cups that are selectively operable to secure the sleeve blank in the loading position; and wherein the conveyor system further comprises a first paddle rotatably mounted proximate the first sidewall and a second paddle rotatably mounted proximate the second sidewall.

A system for sleeving trays according to another embodiment of the present disclosure comprises: a hopper bay configured to store a plurality of sleeve blanks, each sleeve blank in a flattened configuration; a conveyor system; and a robotic arm. The robotic arm is configured to: remove one of the plurality of sleeve blanks from the hopper bay and cause the sleeve blank to transition from the flattened configuration to an open configuration by pushing an edge of the sleeve blank against a portion of the conveyor system; and deposit the one of the plurality of sleeve blanks in the open configuration on the conveyor system.

Aspects of the foregoing system for sleeving trays include: wherein the hopper bay comprises a plurality of hoppers, each of the plurality of hoppers configured to store a plurality of sleeve blanks; wherein the hopper bay comprises: a frame and a conveyor supported by the frame, the conveyor at least partially supporting the plurality of sleeve blanks; wherein the hopper bay comprises: a frame having a forward end proximate the robotic arm; and a push bar configured to selectively exert a force on the plurality of sleeve blanks in the direction of the robotic arm; wherein the conveyor system comprises a conveyor, a first sidewall, and a second sidewall parallel to the first sidewall; wherein the portion of the conveyor system is the second sidewall; and wherein the conveyor system comprises a plurality of selectively operable suction cups for securing the one of the plurality of sleeve blanks in a loading position during insertion of a tray therein.

A system for storing and loading sleeve blanks according to another embodiment of the present disclosure comprises: a sleeve blank hopper; a conveyor system comprising a rotatable side flap, the rotatable side flap comprising a plurality of suction devices; a robotic arm; and a control unit. The control unit comprises: a processor; a communication interface; and a memory storing instructions for execution by the processor that, when executed cause the processor to: transmit a control signal via the communication interface that causes the robotic arm to pick up an empty sleeve blank from the sleeve blank hopper, push the empty sleeve blank against a portion of the convey system to transition the empty sleeve blank from a flattened position to an open position, and release the empty sleeve blank in the open position onto the conveyor system in a loading position.

Aspects of the foregoing system for storing and loading sleeve blanks include: wherein the memory stores additional instructions for execution by the processor that, when executed by the processor, further cause the processor to: transmit a control signal via the communication interface that causes the rotatable side flap to rotate from a lowered position to a raised position;

further comprising a plurality of sleeve blank hoppers, and wherein the memory stores additional instructions for execution by the processor that, when executed by the processor, further cause the processor to: receive, via the communication interface, information from at least one sensor about a size of a tray to be loaded into a sleeve blank; and transmit to the robotic arm, via the communication interface, a control signal based on the information; wherein the sleeve blank hopper further comprises: a second conveyor system; and a cable-and-reel drive system; wherein the memory stores additional instructions for execution by the processor that, when executed by the processor, further cause the processor to: transmit a control signal, via the communication interface, that activates the second conveyor system and the cable-and-reel drive system; and wherein the robotic arm further comprises: an end-of-arm tool comprising a plurality of suction devices.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A10 Fusion processor with 64-bit architecture, Apple® M10 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARM926EJ-S™ processors. A processor as disclosed herein may perform computational functions using any known or future-developed standard, instruction set, libraries, and/or architecture.

I claim:

1. A tray sleeving system comprising:
a robotic arm;
an end-of-arm tool operably connected to the robotic arm, the end of arm tool configured to selectively hold a sleeve blank;
a conveyor system having a first sidewall proximate the robotic arm and a second sidewall distal from the robotic arm, the first sidewall separated from the second sidewall by a conveyor;
a processor; and
a memory storing instructions for execution by the processor, the instructions, when executed by the processor, causing the processor to:
cause the robotic arm to retrieve a sleeve blank with the end-of-arm tool;
cause the robotic arm to push the sleeve blank against the second sidewall so as to cause the sleeve blank to transition from a flattened state to an open state; and
cause the robotic arm to release the sleeve blank into a loading position on the conveyor.

2. The tray sleeving system of claim 1, wherein the end-of-arm tool comprises a plurality of selectively operable suction cups.

3. The tray sleeving system of claim 1, wherein the conveyor system further comprises a plurality of suction cups configured to selectively secure the sleeve blank in the loading position of the conveyor.

4. The tray sleeving system of claim 1, wherein the first sidewall comprises a flap portion, the flap portion rotatable between a first, lowered position and a second, raised position.

5. The tray sleeving system of claim 4, wherein the flap portion comprises a plurality of selectively operable suction cups configured to secure the sleeve blank in the loading position of the conveyor when the flap portion is in the second, raised position.

6. The tray sleeving system of claim 1, wherein the conveyor system further comprises a suction cup mount selectively movable vertically from a lowered position to a raised position, the suction cup mount comprising a plurality of suction cups that are selectively operable to secure the sleeve blank in the loading position.

7. The tray sleeving system of claim 1, wherein the conveyor system further comprises a first paddle rotatably mounted proximate the first sidewall and a second paddle rotatably mounted proximate the second sidewall.

8. A system for sleeving trays, comprising:
a hopper bay configured to store a plurality of sleeve blanks, each sleeve blank in a flattened configuration;
a conveyor system; and
a robotic arm configured to:
remove one of the plurality of sleeve blanks from the hopper bay and cause the sleeve blank to transition from the flattened configuration to an open configuration by pushing an edge of the sleeve blank against a portion of the conveyor system; and
deposit the one of the plurality of sleeve blanks in the open configuration on the conveyor system.

9. The system of claim 8, wherein the hopper bay comprises a plurality of hoppers, each of the plurality of hoppers configured to store a plurality of sleeve blanks.

10. The system of claim 8, wherein the hopper bay comprises:
a frame;
a conveyor supported by the frame, the conveyor at least partially supporting the plurality of sleeve blanks.

11. The system of claim 8, wherein the hopper bay comprises:
a frame having a forward end proximate the robotic arm; and
a push bar configured to selectively exert a force on the plurality of sleeve blanks in the direction of the robotic arm.

12. The system of claim 8, wherein the conveyor system comprises a conveyor, a first sidewall, and a second sidewall parallel to the first sidewall.

13. The system of claim 12, wherein the portion of the conveyor system is the second sidewall.

14. The system of claim 8, wherein the conveyor system comprises a plurality of selectively operable suction cups for securing the one of the plurality of sleeve blanks in a loading position during insertion of a tray therein.

15. A system for storing and loading sleeve blanks, the system comprising:
a sleeve blank hopper;
a conveyor system comprising a rotatable side flap, the rotatable side flap comprising a plurality of suction devices;
a robotic arm; and
a control unit comprising:
a processor;
a communication interface; and
a memory storing instructions for execution by the processor that, when executed cause the processor to:
transmit a control signal via the communication interface that causes the robotic arm to pick up an empty sleeve blank from the sleeve blank hopper, push the empty sleeve blank against a portion of the convey system to transition the empty sleeve blank from a flattened position to an open position, and release the empty sleeve blank in the open position onto the conveyor system in a loading position.

16. The system of claim 15, wherein the memory stores additional instructions for execution by the processor that, when executed by the processor, further cause the processor to:
transmit a control signal via the communication interface that causes the rotatable side flap to rotate from a lowered position to a raised position.

17. The system of claim 15, further comprising a plurality of sleeve blank hoppers, and wherein the memory stores additional instructions for execution by the processor that, when executed by the processor, further cause the processor to:
receive, via the communication interface, information from at least one sensor about a size of a tray to be loaded into a sleeve blank; and
transmit to the robotic arm, via the communication interface, a control signal based on the information.

18. The system of claim 15, wherein the sleeve blank hopper further comprises:
a second conveyor system; and
a cable-and-reel drive system.

19. The system of claim 18, wherein the memory stores additional instructions for execution by the processor that, when executed by the processor, further cause the processor to:
transmit a control signal, via the communication interface, that activates the second conveyor system and the cable-and-reel drive system.

20. The system of claim 15, wherein the robotic arm further comprises:
an end-of-arm tool comprising a plurality of suction devices.
